(19) United States
(12) Patent Application Publication
(10) Pub. No.: US 2015/0052948 A1
(43) Pub. Date: Feb. 26, 2015

(54) METHOD FOR PRODUCING A MOLDED BODY FROM AN ELECTRICALLY MELTED SYNTHETIC QUARTZ GLASS

(71) Applicant: Heraeys Quarzglas GmbH & Co KG, Hanau (DE)

(72) Inventors: Walter Lehmann, Leipzig (DE); Thomas Kayser, Leipzig (DE); Martin Arndt, Newcastle Tyne and Wear (GB); Achim Hofmann, Frankfurt (DE)

(73) Assignee: Heraeus Quarzglas GmbH & Co KG, Leipzig (DE)

(21) Appl. No.: 14/391,005

(22) PCT Filed: Mar. 26, 2013
(86) PCT No.: PCT/EP2013/056364

§ 371 Date: Oct. 6, 2014

(30) Foreign Application Priority Data
Apr. 5, 2012 (DE) 102012006914.6
Apr. 25, 2012 (DE) 10 2012 008 123.5

(51) Int. Cl. C03B 20/00; C03B 5/033; C03B 19/10

(52) U.S. Cl. CPC C03B 20/00; C03B 19/108; C03B 5/033
USPC 65/21.4

(57) ABSTRACT

In a known method for producing a mold body from synthetic quartz glass, quartz glass granules (15) are heated in an electrically heated melt container (31) to form a softened quartz glass mass (57), and the softened quartz glass mass (57) is formed to the mold body. In order to achieve an advantageous melting behavior also in continuous melting processes, it is proposed according to the invention that synthetically produced quartz glass granules (15) of granular particles are used in which helium is enclosed, wherein said quartz glass granules (15) are produced by granulating pyrogenically produced silicic acid with the formation of a SiO₂ granulate (9) and subsequent vitrification of the SiO₂ granulate in a rotary kiln (1), which has a rotary tube (6) which is at least partially made of a ceramic material, and under a treatment gas that contains at least 30% by volume of helium.

### TECHNICAL FIELD

The present invention relates to a method for producing a molded body from electrically melted synthetic quartz glass in that synthetically produced quartz-glass granules are provided and heated in an electrically heated melting vessel so as to form a softened quartz glass mass and the softened quartz-glass mass is molded into the molded body.

Synthetically produced quartz glass granules are obtained by thermal densification of a porous SiO₂ granulate. Such a granulate is produced by pre-densifying SiO₂ soot dust or SiO₂ nanoparticles, as are e.g. obtained in the manufacture of synthetic quartz glass by polymerization, polycondensation, precipitation or CVD methods. Roll granulation, spray granulation, centrifugal atomization, fluidized bed granulation, granulating methods using a granulating mill, compaction, roller presses, briquetting, flake production or extrusion should be mentioned as examples of standard granulation methods.

The discrete, mechanically and possibly also thermally pre-densified particles which are obtained thereby are here called “SiO₂ granulate particles”. In their entirety, they form the porous “SiO₂ granulate”.

Due to their porosity the direct fusion of such SiO₂ granulates poses problems, for during direct fusion there is the risk that closed, gas-filled cavities are formed which cannot be removed or can be removed only at a very slow pace from the highly viscous quartz glass mass and which thereby lead to bubbles in the quartz glass. Therefore, sophisticated applications in which the absence of bubbles in the end product is of importance normally require a preceding vitrification of the porous granulate. The dense glass particles obtained by vitrification of the porous granulate particles SiO₂ are here called “quartz glass particles” which in their entirety form the synthetic “quartz glass granules”.

Such quartz glass granules can be processed in electrically heated melting crucibles or melt molds into components, such as tubes, rods, holders, bells, reactors or crucibles for semiconductor or lamp manufacture and for chemical process engineering, from highly siliceous glass.

“Highly siliceous glass” stands here for undoped or doped quartz glass with a SiO₂ content of at least 90% by wt. Such a glass shall also briefly be called “quartz glass” in the following and the softened mass obtained therefrom shall be called “quartz glass melt”.

The quartz glass melt shows a comparatively high viscosity even at temperatures near the sublimation temperature of SiO₂. Due to their high temperature and viscosity quartz glass melts cannot easily be homogenized by taking measures that are otherwise standard in glass processing, such as refining or stirring.

Therefore, during fusion of quartz glass granules the gas space between the dense quartz glass particles causes additional bubble problems, for the gases entrapped in the melting process within the viscous glass mass can hardly escape later and can also not be removed by way of homogenizing measures. They cause bubbles and other disorders in the finished molded body of quartz glass.

The problem caused by bubble formation is above all observed during the fusion process with a fusion period that is restricted due to the process, e.g. during continuous fusion of quartz glass granules in a crucible type drawing method. In this method a melting crucible is fed from above with quartz glass granules, the granular bulk material produced thereby is heated and fused into a highly viscous quartz glass melt and said melt is continuously drawn off via a drawing nozzle at the crucible bottom as a quartz glass strand of any desired cross-sectional profile. Cylindrical molded bodies are cut to length from the quartz glass strand.

In the crucible type drawing method, gases that are entrapped in the viscous quartz glass melt are very difficult to remove. They cause bubbles and other disorders in the drawn-off quartz glass strand, and they can lead to irregularities in the drawing process and thus to dimensional deviations.

### PRIOR ART

It follows from the above explanations that the problems caused by bubble inclusion play an important role both during vitrification of the porous SiO₂ granulate into synthetic quartz glass granules and during fusion of the quartz glass granules produced thereby into the molded body of quartz glass. With the aim to achieve the absence of bubbles or a low content of bubbles in the respective process stage, a multitude of different techniques are known.

Vitrification of Granulate into Quartz Glass Granules

EP 1 076 043, for instance, suggests that porous SiO₂ granulate should be poured into a burner flame to finely disperse the same therein and to vitrify it at temperatures of 2000-2500° C. The granulate is preferably obtained by spray or wet granulation of filter dust and has grain sizes in the range of 5 μm to 300 μm. Prior to vitrification it can be heated by treatment with microwave radiation and can be pre-densified.

The degree of sintering of a given granulate particle depends on its particle size and on the heat input which, in turn, is determined by the residence time in the burner flame and the flame temperature. As a rule, however, the granulate shows a certain particle size distribution, and the combustion gas flame has regions of different flow velocities and flame temperatures. This leads to irregular and hardly reproducible sintering degrees. Moreover, there is the risk that the quartz glass particles are contaminated by the combustion gases. Loading with hydroxyl groups upon use of hydrogen-containing combustion gases should here particularly be mentioned, which is accompanied by a comparatively low viscosity of the quartz glass.

EP 1 088 789 A2 suggests for the vitrification of porous SiO₂ granulate that synthetically produced granulate should first be cleaned by heating in HCl-containing atmosphere in a rotary kiln, that it should subsequently be calcined in a fluidized bed and then vitrified in a vertical fluidized-bed apparatus or in a crucible under vacuum or helium or hydrogen to obtain synthetic quartz-glass granules.

This represents a discontinuous vitrification process accompanied by great thermal inertia of the kiln and thus long process periods with correspondingly great efforts in terms of time and costs with a low throughput and with a granulate that is relatively expensive on the whole.

In a similar method according to JP 10287416A, particulate SiO₂ gel with diameters in the range between 10 μm and 1,000 μm is continuously densified in a rotary kiln. This kiln comprises a rotary tube of quartz glass having a length of 2 m and an inner diameter of 200 mm. The rotary tube is heated by means of heaters from the outside and is divided into plural temperature zones that cover the temperature range of 50° C. to 1,100° C. The particulate SiO₂ gel with particles sizes between 100 μm and 500 μm is freed of organic constituents in the rotary tube, which is rotating at 8 rpm, by supply of an oxygen-containing gas and is sintered to form SiO₂ powder. The kiln atmosphere during sintering contains oxygen and, optionally, argon, nitrogen or helium.

The SiO₂ powder obtained thereafter contains, however, also silanol groups in a high concentration of not less than 1,000 wt. ppm. For the elimination thereof the SiO₂ powder is subsequently calcined and dense-sintered at an elevated temperature of 1,300° C. in a quartz glass crucible with an inner diameter of 550 mm in batches of 130 kg.

The thermal stability of a rotary tube of quartz glass limits the use thereof at a high temperature for the vitrification of the granulate particles. During vitrification in the quartz glass crucible, however, there may occur a caking of the sintering granulate particles, resulting in an undefined pore-containing quartz glass mass.

WO 88/03914 A1 also teaches the reduction of the BET surface area of an amorphous porous SiO₂ powder using a rotary kiln in a helium- and/or hydrogen-containing atmosphere.

In a first procedure fine SiO₂ soot dust is put into a rotary kiln, heated in air to 1200° C. and kept at this temperature for 1 h. The result of this process should be a free-flowing, spherical granulate with grain sizes of 0.1 mm to 5 mm, and a BET surface area of <1 m²/g is mentioned. Soot dust is however not free-flowing, it is extremely sinter-active, and it can be easily blown away. The processing of soot dust in a rotary kiln is therefore extremely difficult. In a modification of this procedure, it is suggested that SiO₂ soot dust should be mixed with water, resulting in a moist crumb-like mass. This mass is put into a rotary kiln and densified at a temperature of 600° C. into a powder having grain sizes of 0.1 mm to 3 mm. The SiO₂ powder that has been pre-densified in this way is subsequently vitrified in a separate kiln.

DE 10 2004 038 602 B3 discloses a method for producing electrically melted synthetic quartz glass for use in the manufacture of lamps and semiconductors. Thermally densified SiO₂ granulate is used as the starting material for the electrically melted quartz glass. The granulate is formed by granulating an aqueous suspension consisting of amorphous, nanoscale and pyrogenic SiO₂ particles produced by flame hydrolysis of SiCL₄.

For increasing the viscosity the SiO₂ granulate is doped with Al₂O₃ by adding nanoparticles of pyrogenically produced Al₂O₃ or a soluble aluminum salt to the suspension.

This yields round granulate grains having outer diameters in the range between 160 μm and 1000 μm. The granulate is dried at about 400° C. in the rotary kiln and densified at a temperature of about 1420° C. up to a BET surface area of about 3 m²/g.

For complete vitrification the individual grains of the granulate are then completely vitrified in different atmospheres, such as helium, hydrogen or vacuum. The heating profile during vitrification of the granulates comprises heating to 1400° C. at a heating rate of 5° C./min and a holding time of 120 min. After this treatment the individual granulate grains are vitrified in themselves. The grains are present in individual form without being melted into a mass.

The granulate is further processed in an electric melting process to obtain quartz glass; it is e.g. melted in a crucible to obtain a molded body, or it is continuously drawn into a strand in a crucible type drawing method.

Vitrification is here also carried out in a separate kiln, so that this is also a discontinuous method with a plurality of cost-intensive heating processes.

U.S. Pat. No. 4,255,332 A describes the use of a rotary kiln for producing glass particles for filtering purposes. Finely ground glass powder with particle sizes of around 100 μm is mixed with water and binder and processed into granulate particles with particle sizes of about 300 μm to 4.5 mm. These particles are sintered in a rotary kiln having a rotary tube of mullite into substantially spherical pellets with sizes of around 500-4000 μm.

### Melting of the Quartz Glass Granules for Producing a Molded Body of Quartz Glass

To counteract the inclusion of gases in a crucible drawing process, it is suggested in DE-OS 25 50 929 that an atmosphere of helium and hydrogen should be maintained in the interior of the melting crucible. These two gases diffuse quartz glass at a comparatively fast rate. They can displace other gases of a slower diffusion rate from existing interstices in the bulk granules in advance, and they are able to escape from the viscous quartz-glass melt even within the short period of the crucible drawing method that is typical of this process. Moreover, hydrogen may dissolve in quartz glass while forming hydroxyl groups. Both the formation of bubbles and the growth of bubbles can thereby be reduced.

However, it has been found that, despite this measure, bubbles may form in the molded body of quartz glass. This may be due to the fact that, while the gases helium or hydrogen are being supplied, preferred flow channels are formed in the bulk granulate, the channels leading locally to a relatively high gas concentration while being absent at other places of the bulk material for an adequate exchange of the existing gases by helium or hydrogen.

Both the locally enhanced gas concentration and a locally inadequate gas exchange may contribute to the formation of bubbles.

### TECHNICAL OBJECT

It is the object of the present invention to indicate a method which, starting from porous SiO₂ granulate, allows the production of dense synthetic quartz-glass granules which, when used in an electro melting process, manifest an advantageous fusion behavior, thereby permitting the reproducible manufacture of molded bodies of quartz glass that are as bubble-free as possible, namely particularly also in continuous fusion processes.

### GENERAL DESCRIPTION OF THE INVENTION

This object, starting from a method of the above-mentioned type, is achieved according to the invention by a method in that synthetically produced quartz glass granules of granular particles are used, in which helium is entrapped, whereby the provision of said granular particles comprises the following steps:
(a) granulation of pyrogenically produced silicic acid so as to form a SiO₂ granulate of porous granulate particles; and
(b) vitrifying the SiO₂ granulate in a rotary kiln having a rotary tube consisting at least in part of ceramic material, and in a treatment gas which contains at least 30% by vol. of helium so as to form the granular particles with entrapped helium.

Already during the vitrification of the porous SiO₂ granulate into dense helium-containing quartz glass granules the method according to the invention already creates an essential precondition for the advantageous further processing thereof by fusion into a substantially bubble-free molded body.

The SiO₂ granulate is obtained in that pyrogenically produced silicic acid—hereinafter also called “SiO₂ soot dust”—is pre-densified with the help of standard granulation methods. The granulating process can be performed by using a rotary tube, as is known from the prior art. The result is at any rate a porous SiO₂ granulate. This granulate is vitrified in a rotary kiln with a heated rotary tube rotating about a central axis, which is slightly inclined in the longitudinal direction of the furnace so as to induce the transportation of the granulate from its inlet side to the outlet side. Special demands, which shall be explained hereinafter, are due to the high temperature and the accompanying material load.

Viewed over the length of the rotary tube, a temperature profile is produced during vitrification with a temperature maximum that is higher than the softening temperature of quartz glass, i.e. above 1150° C. To allow this without deformation of the rotary tube, at least the portion of the rotary tube that is mostly loaded thermally consists of a temperature-resistant ceramic material having a higher softening temperature than undoped quartz glass.

The rotary tube consists of one part or of a plurality of parts, the inner wall of the rotary tube consisting of the temperature-resistant ceramic material at least over the sub-length that is exposed to the maximum temperature load. The rotary tube may have an inner lining. Apart from a possible metallic enclosure, the rotary tube consists completely of a ceramic material in the simplest case.

The granulate particles are heated in the rotary tube to a temperature that is sufficient for vitrification. The quartz glass particles obtained therefrom after vitrification have a specific surface area of less than 1 cm²/g (determined according to DIN ISO 9277-May 2003. “Bestimmung der spezifischen Oberfläche von Feststoffen durch Gasadsorption nach dem BET-Verfahren”). The surface is dense; the particles may here be transparent or partly opaque.

To enable the vitrification of the bulk material consisting of porous SiO₂ granulate in the rotary tube, another precondition is an atmosphere containing helium. Only an atmosphere containing enough helium permits a bubble-free or specifically low-bubble vitrification of the porous granulate particles at a low temperature and/or with short vitrification durations, as are possible under the conditions of rotary kiln vitrification. Possibly entrapped gases consist mainly (e.g. at least 90 vol. %) of helium. Instead of helium, hydrogen would also be suited in principle for a low-bubble vitrification; however, loading of the vitrified quartz glass particles does not lead during later fusion of the granules to outgassing and to a local improvement of the heat conduction to the extent as is the case with helium loading. Amounts of hydrogen in the vitrification atmosphere are however harmless.

It is therefore intended according to the invention that during vitrification the rotary tube is either flooded with a treatment gas or that it is flushed with this treatment gas continuously or from time to time, wherein the treatment gas consists of at least 30 vol. % of helium and at the same time contains hardly any, or ideally no, nitrogen, for it has been found that granulate particles vitrified in the presence of nitrogen tend to have a higher bubble content.

When traveling through the rotary tube, the granulate particles are exposed to mechanical forces which are produced by the weight and the circulation of the bulk material. Possible agglomerates of the vitrified granules are here dissolved again.

Vitrification in the rotary kiln comprises one pass or plural passes. In the case of plural passes the temperature can be raised from pass to pass. In the case of plural passes a lower bubble content is achieved in the quartz glass granules.

The vitrified quartz glass granules can be fused directly for producing molded parts of quartz glass. It has however been found that depending on the fusion technique and in the case of very high demands made on the absence of bubbles in the molded parts of quartz glass, the above-explained vitrification measures in the rotary kiln are per se not sufficient, although the resulting granules evidently seem to be completely transparent. The reason is that when the quartz glass granules are further processed in electric melting methods as bulk material, it is not only a possible gas content of the granules as such that is noticed in terms of bubble formation, but also gases between the quartz glass particles of the bulk material. Normally one tries to expel these gases by flushing with helium, which is however accompanied by the formation of preferred gas stream channels with the above-explained disadvantages of an inhomogeneous loading with helium.

The invention therefore chooses a different route. The quartz glass granules intended for electric melting processes are vitrified in the rotary tube such that they maintain a certain content of helium also after cooling. The entrapped helium is gradually released during the subsequent electric melting process, it expands due to the high temperature in the melting process to many times its original volume and thereby expels the foreign gas present between the quartz glass particles of the bulk material. The following is also of importance: helium is distinguished by a high thermal conductivity. The even and continuous release of even small amounts of helium therefore has the further advantageous effect that the temperature across the bulk material is made uniform, which contributes to a better and more homogeneous fusion.

The helium release from the quartz glass particles is carried out continuously and uniformly over the whole bulk material. An additional flushing of the bulk material by introducing helium into the melt container can thus be omitted, or the helium amount used for flushing can be reduced in comparison with helium-free feedstock granules.

The helium release from the quartz glass particles is the more pronounced the higher the initially entrapped helium content is. Preferably, the volume of the helium entrapped in the granular particles is at least 0.5 cm³/kg, preferably at least 10 cm³/kg.

The above-described vitrification process under helium leads to a relatively high loading of the quartz granules with this glass. The content of helium per 1 kg quartz glass granules is such that the helium during outgassing under normal conditions (at room temperature (25° C.) and atmospheric pressure) occupies a gas volume of at least 0.5 cm³, preferably at least 10 cm³. During fusion one obtains—on account of the thermal expansion—a gas volume of helium up to three or four times the gas volume under normal conditions. The gas volume is determined in that the granules are heated up until softening and the escaped gas species and its specific volume are determined.

The helium content in the vitrified granules is adjustable through the content of helium in the atmosphere of the rotary kiln. It has turned out to be useful when the treatment gas during vitrification according to method step (b) contains at least 50% helium, preferably at least 95%.

Owing to the use of helium during vitrification it is possible to completely vitrify the porous granulate particles at a comparatively low temperature and within a short period of time. Furthermore, owing to a high content of helium in the vitrification atmosphere of more than 50% by volume, one additionally achieves a particularly high density and a low bubble content of the vitrified granules. The residual amount of the vitrification atmosphere can be formed by inert gases or by nitrogen and/or oxygen, wherein the volume fraction of the two last-mentioned gases is preferably less than 30% by volume.

The quartz glass granules vitrified in this way thereby contains helium due to the manufacturing process. To give the helium entrapped in the quartz glass granules as little time as possible for out-diffusion, the cooling process after vitrification is carried out as fast as possible.

For the above-explained reasons the quartz glass granules which are loaded with helium exhibits a favorable fusion behavior in an electric melting process, especially also under difficult fusion conditions, i.e., in the case of short melting periods and large melting masses, so that the duration for removing residual gases from the bulk material in the melting process is limited, and there are particularly high demands made on the reproducibility of the temperature distribution within the melting vessel, e.g. during continuous fusion of the granules in a vertical type crucible drawing method.

Preferably, the quartz glass granules are therefore used for an application in which the melting vessel is configured as a heated melting mold with bottom outlet through which the softened quartz-glass mass is continuously withdrawn as a quartz-glass strand.

The loading capacity of the quartz glass particles with helium and thus the outgassing duration in the fusion process depend on the size of the quartz glass particles. Their size is determined by the original size of the granulate particles. The method according to the invention yields particularly good results on condition that the granulate particles have a mean grain size between 100 μm and 400 μm, preferably between 200 μm and 400 μm.

Granulate particles with a mean grain size of more than 1000 μm can be vitrified only at a slow pace. Particularly fine-grained quartz glass granules tend to caking with the rotary tube wall.

To minimize said effect, it has turned out be useful to set a fines content of the SiO₂ granulate with particles sizes of less than 100 μm in advance in such a manner that it accounts for less than 10% by wt. of the total weight of the granulate.

For a vitrification of the granulate particles that is as uniform as possible and for a loading with helium that is as homogeneous as possible, approximately identical particle sizes are advantageous. In this respect it has turned out to be useful when the granulate particles have a narrow particle size distribution in which the particle diameter assigned to the D₉₀ value is at the most twice as large as the particle diameter assigned to the D₁₀ value. A narrow particle size distribution exhibits a comparatively low bulk density, which counteracts agglomeration during vitrification. Moreover, in the case of an ideally monomodal size distribution of the granulate particles, the weight difference between the particles is no longer applied as a parameter for a possible separation within the bulk material, which is conducive to a more uniform vitrification of the bulk material.

The porous granulate particles are heated in the rotary tube to a temperature which generates vitrification. A temperature in the range of 1300° C. to 1600° C. has turned out to be useful. At temperatures of less than 1300° C., a long treatment period is needed for complete vitrification. Preferably, the temperature is at least 1450° C. At temperatures above 1600° C. rotary kiln and furnace are thermally loaded to an excessive degree.

The mechanical load on the granulates due to rotation of the rotary tube reduces the risk of agglomerate formations. At high temperatures above about 1400° C. the quartz glass is however partly softened, so that adhesions to the rotary tube wall may be observed in the areas showing hardly any movement.

To avoid such a situation, it is intended in a preferred procedure that the granulate particles are subjected to vibration.

Vibration can be produced by shaking or striking or by ultrasound. It is carried out regularly or in pulsed fashion from time to time.

The high vitrification temperature can be produced by burners acting on the granulate particles. Preferred is however a procedure in which heating is carried out by means of a resistance heater surrounding the rotary tube.

The heat input from the outside via the rotary tube requires a configuration consisting of a temperature-resistant ceramic material, as has been explained above. This type of heating prevents a situation where the granulate particles are influenced by a combustion gas mechanically (by blowing away) or chemically (by impurities).

A substance that simultaneously increases the viscosity of quartz glass, preferably Al₂O₃, ZiO₂ or Si₃N₄, is advantageously suited as a material for the rotary tube.

In this case the material exhibits the additional characteristic that it contains a dopant that contributes to an increase in the viscosity of quartz glass and thus to an improvement of the thermal stability of quartz glass components. The porous granulate particles that do not contain the dopant or contain it in an inadequate concentration are continuously heated in the rotary tube and thereby circulated. Contact with the dopant-containing inner wall yields a finely divided abrasion which leads or contributes to a desired doping of the granulate particles. As a rule, the dopant is present in the quartz glass as an oxide. Hence, a central idea of this embodiment of the method according to the invention consists in carrying out the complete vitrification of the porous SiO₂ granulate particles in a rotary kiln at a high temperature, which is made possible by way of a suitable atmosphere during vitrification and by a temperature-resistant material for the rotary tube, which simultaneously serves—due to abrasion—as a dopant source for the quartz glass granules. This method permits a continuous vitrification of the SiO₂ granulate particles and thus homogeneous loading with the viscosity-enhancing dopant at the same time.

Especially Al₂O₃ and nitrogen (in the form of Si₃N₄) are suited as suitable dopants in this sense. For an adequate input of said dopants it is advantageous when the inner wall of the rotary tube consists at least in the highly loaded portion of at least 90% by wt., preferably at least 99% by wt., of the substance in question.

Al₂O₃, in particular, is distinguished by a high temperature resistance, a high thermal shock resistance and corrosion resistance. In the simplest case the whole inner wall of the rotary tube consists of Al₂O₃. Otherwise, the part of the rotary tube that is exposed to the highest temperature load consists of Al₂O₃.

At high temperatures the granulate particles and the vitrified quartz-glass particles may be contaminated by abrasion of the material of the inner wall of the rotary tube. Already minor alkali contents enhance the tendency of quartz glass to devitrification to a considerable extent. Therefore, the substance of the inner wall of the rotary tube preferably comprises an alkali content of less than 0.5%.

For doping the quartz glass particles with Al₂O₃ this contamination is counteracted by way of impurities if the rotary tube consists of synthetically produced Al₂O₃.

Synthetically produced Al₂O₃ with a purity of more than 99% by wt. is known under the trade name “Alsint”. To minimize the costs of the material, the synthetic material can be limited to the area of a thin inner lining of the rotary tube.

When an Al₂O₃-containing rotary tube is used, the quartz glass granules can thereby be Al₂O₃-doped in the range of from 1 to 20 wt. ppm in a simple manner.

As an alternative, the inner wall of the rotary tube consists of ZrO₂ or TiO₂.

These materials are distinguished by sufficiently high melting temperatures for the vitrification of the SiO₂ granulate (ZrO₂: about 2700° C.; TiO₂: about 1855° C.) and they are harmless as contamination in a small concentration for many applications, e.g. for semiconductor manufacturing.

With respect to a reproducible and cost-effective production method the SiO₂ granulate is subjected prior to vitrification to a cleaning process by heating in a halogen-containing atmosphere, wherein the cleaning of the SiO₂ granulate is carried out in a second rotary kiln.

In this variant of the method, the thermal high-temperature treatment steps subsequent to granulate production, i.e. cleaning and vitrification, are each carried out in a rotary kiln.

This achieves a substantially continuous production process, and a change of the kiln system is avoided. This facilitates timing as well as spatial adaptation in successive treatment steps and helps to shorten the cycle time of the granulate.

The rotary kilns are tailored to the specific requirements of the respective treatment step. A rotary kiln may here be subdivided into a plurality of treatment chambers kept separate from one another. To be more specific, in the case of a granulate that is already substantially dry, finish drying as well as cleaning can be carried out in a method step in a cleaning furnace. Ideally, however, a separate rotary kiln is provided for each of the treatment steps drying, cleaning and vitrifying. Treatment duration, temperature and atmosphere can thereby be optimally adapted to the respective process independently of each other, which results in a qualitatively better end product. As a result, e.g. during the transitions from drying to cleaning and from cleaning to vitrifying it is e.g. possible to utilize the residual heat of the preceding process.

In the case of rotary tubes of different materials, these may be butt-joined, but are preferably inserted into one another with a certain play to mitigate problems caused by different thermal expansion coefficients of the respective materials.

To be able to adjust the atmospheres in the different zones of the rotary kiln substantially independently of one another, neighboring zones of the rotary kiln are fluidically separated from one another to a certain degree and for this purpose they are preferably subdivided by separating screens provided with openings or by labyrinth traps.

The cleaning in the rotary kiln is carried out in a chlorine-containing atmosphere at a temperature in the range between 900° C. and 1250° C. The chlorine-containing atmosphere particularly achieves a reduction of alkali and iron contaminations from the SiO₂ granulate. At temperatures below 900° C. there will be long treatment durations, and at temperatures above 1250° C. there is the risk of dense-sintering the porous granulate with inclusion of chlorine or gaseous chlorine compounds.

In the sense of a substantially continuous procedure only one rotary kiln is used also for drying and cleaning the SiO₂ granulate, said kiln, viewed in the direction of the central axis, being subdivided into zones, comprising a drying zone and a cleaning zone.

The subdivision into zones is preferably carried out again by separating screens provided with openings or by labyrinth traps. In the area of the drying and cleaning zone, the inner wall of the rotary tube consists preferably of quartz glass so as to avoid contamination of the granulate.

If several process steps take place in a joint rotary kiln, such as drying/cleaning or cleaning/vitrification, each of the zones may be provided with its own heater. For good energy exploitation the rotary tubes for cleaning and vitrification are each heated by means of a resistance heater surrounding the rotary tube.

Drying of the granulate is carried out preferably by heating in air at a temperature in the range between 200° C. and 600° C.

In this procedure a separate drying furnace which is preferably designed as a rotary kiln is provided for drying the granulate. The temperature is constant or is increased as the drying process is progressing. At temperatures below 200° C. one obtains long drying durations. Above 600° C., entrapped gases may exit rapidly; this may lead to the destruction of the granulates.

The vitrified quartz glass particles can be used for producing components of opaque or transparent quartz glass, as e.g. a tube of opaque quartz glass which is produced in a centrifugal process. They can also be used per se as a particulate start material for producing a quartz glass cylinder in the so-called Verneuil process or can be further processed and fused for producing a quartz glass crucible by way of an electric are or by means of plasma.

In these procedures, the quartz glass particles are suddenly sintered, so that there remains little time for the outgassing of the entrapped helium. Here, gas entrapped in the vitrified particles has a rather bubble-forming effect, i.e. it is disadvantageous. According to the invention the quartz glass particles are however used on account of their comparatively high helium content by fusion in an electrically heated melting vessel, as has been explained above. This vessel provides an inner chamber into which the entrapped helium can escape and develop its melt-conducive effect for a certain period of time.

### EMBODIMENT

The invention shall now be described in more detail with reference to an embodiment and a drawing. In a schematic illustration,

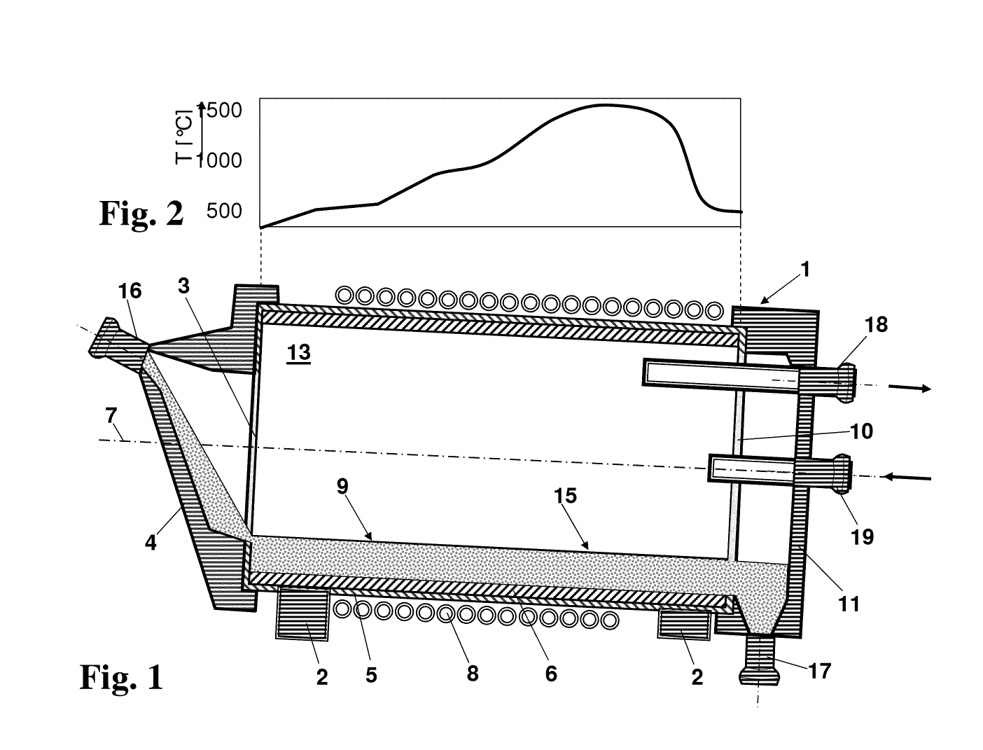

FIG. 1 shows a rotary kiln for performing the vitrification and aftertreatment step in the method according to the invention, in a side view;

FIG. 2 shows a temperature profile over the length of the rotary kiln; and

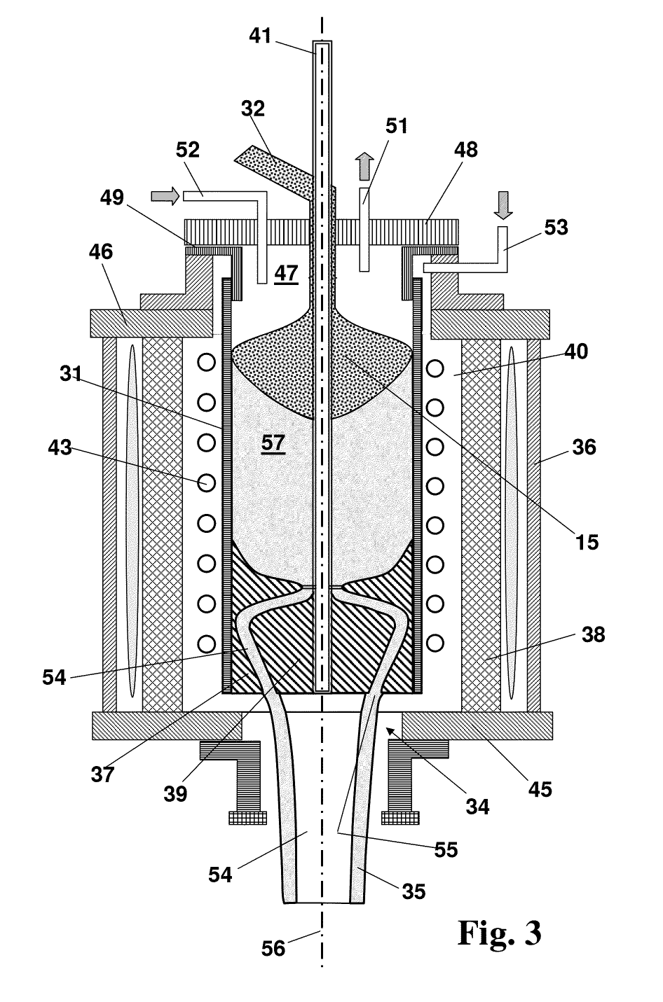

FIG. 3 shows a crucible melting apparatus for drawing a strand of quartz glass according to the invention.

FIG. 1 shows a rotary kiln 1 which is supported on rollers 2. The rotary kiln 1 substantially comprises a frame 5 of SiC in which a rotary tube 6 of synthetically produced Al₂O₃ (trade name Alsint) with an inner diameter of 150 mm and a length of 1.8 m is fixed. The rotary tube 6 is rotatable about a central axis 7 and heatable by means of a resistance heater 8 provided on the outer jacket.

The rotary kiln 1 is slightly inclined in longitudinal direction 7 relative to the horizontal to induce the transportation of a loose material consisting of porous SiO₂ granulate 9 from the inlet side 3 of the rotary kiln 1 to the removal side 10. The open inlet side 3 is closed by means of a rotatorily fixed inlet housing 4. The inlet housing 4 is equipped with an inlet 16 for the supply of porous SiO₂ granulate 9 and with a further inlet (not shown) for the supply of helium and other treatment gases.

The open removal side 10 of the rotary tube 6 is closed by means of an also rotatorily fixed removal housing 11. The removal housing 11 is provided with an outlet 17 for the removal of vitrified quartz glass granules 15; gas can also flow via said outlet out of the rotary kiln 1. For the suction of gas a suction nozzle 18 is provided that is arranged in the upper area of the rotary kiln 1. Furthermore, the removal housing 11 is equipped with a gas inlet nozzle 19 by means of which a gas, for instance argon, is introduced into the rotary tube 6.

The method according to the invention shall now be described in more detail with reference to embodiments:

### Producing, Drying and Cleaning of SiO₂ Granulate

### Example A

The granulate was produced by granulating a slurry with 60% by wt. of residual moisture from pyrogenic silicic acid (nanoscale SiO₂ powder, SiO₂ soot dust) and demineralized water in the intensive mixer. After granulation the residual moisture is <20%. The granulate was sieved to grain sizes of <3 mm.

The residual moisture was lowered to <1% by drying at 400° C. in a rotary kiln (throughput: 20 kg/h) in air. Sieving to the fraction 100-750 μm is carried out; this means that the fines fraction with grain sizes of <100 μm is removed.

Subsequently, cleaning and further drying in HCl-containing atmosphere is carried out in the rotary kiln at a maximum temperature of 1040° C. (throughput: 10 kg/h). The specific surface area (BET) is here reduced by about 50%.

This yielded a SiO₂ granulate of synthetic undoped quartz glass of high purity. It consists essentially of porous spherical particles with a particle size distribution having a D₁₀ value of 200 μm, a D₉₀ value of 400 μm, and a mean particle diameter (D₅₀ value) of 300 μm.

### Example B

The granulate was produced by high-speed granulation from pyrogenic silicic acid (nanoscale SiO₂ powder, SiO₂ dust) and demineralized water in the intensive mixer. For this purpose demineralized water is fed into the intensive mixer and pyrogenic silicic acid is added under mixing until the residual moisture is about 23% by wt. and a granulate is produced. The granulate is sieved to grain sizes of <2 mm. Coarse particles can be crushed in advance by using a roller crusher for increasing the yield.

The residual moisture is lowered to <1% by drying at 350° C. in a rotary kiln (throughput 15 kg/h) in air. The fines fraction with grain sizes <100 μm was removed; otherwise, no further sieving operation was carried out.

Subsequently, cleaning and further drying are carried out in HCl-containing atmosphere in the rotary kiln at temperatures of 1050-1150° C. (throughput: 10 kg/h). The sum of chemical contaminants is reduced during hot chlorination to less than 1/10 of the starting material (i.e., to <10 ppm).

The granulate consists essentially of porous spherical particles having a particle size distribution with a D10 value of 300 μm, a D90 value of 450 μm and a mean particle diameter (D50 value) of 350 μm.

### Vitrification of the Granulate

The rotary tube 6 which is rotating about its rotation axis 7 at a rotational speed of 8 rpm is continuously fed with undoped porous SiO₂ granulate 9 at a feed rate of 15 kg/h.

The rotary tube 6 is inclined in longitudinal direction 7 at the specific angle of repose of the granulate particles 9, so that a uniform thickness of the loose granulate is set over the length thereof. The uniform loose-material thickness contributes to a uniform action of helium and facilitates homogeneous vitrification. The loose material shown in FIG. 1 in the inlet housing 4 shows a different angle of repose; this only serves a simplified schematic illustration.

The interior 13 of the rotary tube 3 is flooded with helium; the helium content of the atmosphere is about 90% by volume. The loose granulate is continuously circulated and heated in this process by means of the resistance heater 8 within the rotary tube 6 and gradually vitrified into quartz glass particles 15. The maximum temperature shortly before approximately the rear third of the rotary tube 6 is about 1460° C. The rotary tube 6 of Al₂O₃ withstands said temperature without difficulty.

Since the rotary tube 6 is heated up and near to the outlet housing 11, the temperature rapidly decreases from the maximum value to the outlet housing 11. At the housing the mean surface temperature of the vitrified granules 15 is slightly more than 500° C.

An axial temperature profile over the length of the rotary tube 6, which has so far been considered to be ideal, is schematically illustrated in the diagram of FIG. 2. The temperature T of the surface of the loose granulate 9 (determined by means of pyrometer) is plotted on the y-axis against the axial position in the rotary tube 6. Directly after having been supplied, the granulate is dried at a temperature of about 500° C. for a duration of 30 min, and it is subsequently pre-densified thermally at a gradually rising temperature at about 1000° C. to 1300° C. The gas contained in the porous granulate is here replaced by helium at the same time. The densification and gas-exchange process lasts for about 60 min. Subsequently, the loose granulate 9 is heated up for complete vitrification, thereby reaching a maximum temperature of about 1460° C. By that time the mean residence time in the rotary kiln 6 is about 3 h.

In this process stadium the helium content of the vitrified quartz glass particles 15 is relatively high. Thereafter, the vitrified and highly helium-loaded quartz glass particles 15 are rapidly cooled down, so that degasification is substantially avoided in that helium has hardly any chance to diffuse out of the dense quartz glass granules. After completion of the vitrification process the gas volume of theoretically releasable helium gas per kg quartz glass granules is about 3 cm³ (gas volume standardized to 25° C. and atmospheric pressure).

The above-mentioned process parameters in combination with the residence time of the granulate 9 in the rotary kiln 1 and the helium atmosphere in the vitrification zone 13 have the effect that the open porosity is mainly disappearing. The surface is dense. The quartz glass particles 15 are evidently completely transparent upon removal in this method stage.

If agglomerates are arising, these will disintegrate again due to the mechanical stress in the moving loose granulate material 9 or by vibration of the rotary tube 6.

At the same time one can observe a uniform abrasion of Al₂O₃, which passes onto the surface of the granulate particles 9 and into the pores thereof. The vitrified quartz glass granules produced thereby are homogeneously doped with Al₂O₃ at about 15 wt. ppm. Adhesions to the inner wall of the rotary tube 6 are mainly avoided.

The completely vitrified and homogeneously doped quartz glass granules have a density of more than 2.0 g/cm³ and a BET surface area of less than 1 m2/g, and they have a relatively low helium content. The quartz glass granules are continuously removed via the discharge housing 11 and the outlet nozzle 17.

Drawing of a Quartz Glass Tube from a Crucible

The helium-loaded quartz glass granules which are produced thereby and which are homogeneously doped with Al₂O₃ are used for producing a quartz glass tube in a vertical type crucible drawing method.

The drawing furnace 1 which is schematically shown in FIG. 3 comprises a melting crucible 31 of tungsten into which the vitrified quartz glass granules 15 are filled continuously from above via a feed nozzle 32.

The melting crucible 31 is surrounded by a water-cooled kiln shell 36 with formation of a protective-gas chamber 40 which is flushed with protective gas and within which a porous insulation layer 38 of oxidic insulation material and a resistance heater 43 for heating the SiO₂ granules 15 are accommodated. The protective-gas chamber 40 is open downwards and otherwise sealed with a bottom plate 45 and a cover plate 46 to the outside. The melting crucible encloses a crucible interior 47 which is also sealed to the environment by means of a cover 48 and a sealing element 49.

An inlet 53 protrudes through the cover 48, and an outlet 51 for a crucible interior gas. This is a gas mixture consisting of 90% by vol. of hydrogen and 10% by vol. of helium. The protective-gas chamber 40 is provided in the upper region with a gas inlet 53 for pure hydrogen.

A drawing nozzle 34 of tungsten is located in the bottom region of the melting crucible 31. This nozzle is composed of a drawing-nozzle external part 37 and a mandrel 39. The mandrel 39 of the drawing nozzle 34 is connected to a holding tube 41 of tungsten which extends through the crucible interior 47 and is guided via the upper cover 48 out of said interior. Apart from holding the mandrel 39, the holding tube 41 also serves to supply a process gas for setting a predetermined blow pressure in the inner bore 54 of the tubular strand 35.

The soft quartz glass mass 57 passes via a flow channel 54 between mandrel 39 and drawing-nozzle external part up to the nozzle outlet 55 and is drawn off as a tubular strand 35 with an inner diameter of 190 mm and an outer diameter of 210 mm vertically downwards in the direction of the drawing axis 56.

The weight of the quartz glass mass 57 produces a “hydrostatic pressure” in the area of the nozzle outlet 55, whereby the softened quartz glass mass 57 passes through the annular gap at a flow rate of about 28 kg/h.

When passing through the melting crucible 1 from the top to the bottom, the quartz glass granules release the entrapped helium, so that the helium is evenly distributed within the loose material of the quartz glass granules 15, expels the air prevailing at that place and contributes—owing to its good thermal conductivity—to a homogeneous and uniform heating.

The drawn-off quartz glass tube was optically examined with respect to bubbles, inclusions and striae. The results are summarized in Table 1 under Sample A. In the Comparative Sample C helium-free standard quartz-glass granules of the same grain size were used and equally processed as explained above for Sample A. In Sample C standard quartz glass and quartz glass granules containing helium were homogeneously mixed before in the ratio of 50:50.

TABLE 1

| | A | B | C |
|---|---|---|---|
| Helium loading | 100 | 50:50 | 0 |
| Bubbles | ++ | + | − |
| Striae | + | + | − |
| Inclusions | + | + | 0 |

The quality as to the occurrence of bubbles, striae and inclusions is qualitatively assessed in Table 1. The symbols of the qualitative assessment are as follows:
“++” very good,
“+” good,
“0” acceptable,
“−” poor

1. A method for producing a molded body from electrically melted synthetic quartz glass, said method comprising:
providing synthetically-produced quartz-glass granules and
heating the synthetically-produced quartz-glass granules in an electrically heated melting vessel so as to form a softened quartz glass mass; and
molding the softened quartz-glass mass into the molded body
wherein the synthetically-produced quartz glass granules are of granular particles that have helium entrapped therein,
wherein said granular particles are provided by a process that comprises:
granulation of pyrogenically-produced silicic acid so as to form a SiO₂ granulate of porous granulate particles; and
vitrifying the SiO₂ granulate in a rotary kiln having a rotary tube that is at least in part of ceramic material, and in a treatment gas that contains at least 30% by vol. of helium so as to form the granular particles with entrapped helium.

2. The method according to claim 1, wherein the helium entrapped in the granular particles occupies a volume of at least 0.5 cm³/kg.

3. The method according to claim 1, wherein the treatment gas during the vitrifying contains at least 50% helium.

4. The method according to claim 1, wherein the melting vessel is a heated melting mold with a bottom outlet through which the softened quartz-glass mass is continuously withdrawn as a quartz-glass strand.

5. The method according to claim 1, wherein the granulate particles have a mean grain size between 20 μm and 2000 μm (D₅₀ value each time).

6. The method according to claim 1, wherein a fines content of the SiO₂ granulate with particle sizes of less than 100 μm is set in advance so that said fines content accounts for less than 10% by wt. of a total weight of the granulate.

7. The method according to claim 1, wherein the granulate particles are heated during the vitrifying to a temperature in the range of from 1300° C. to 1600° C.

8. The method according to claim 1, wherein the granulate particles or the quartz-glass granules are subjected to vibration.

9. The method according to claim 1, wherein the granulate particles are heated by means of a resistance heater surrounding the rotary tube.

10. The method according to claim 1, wherein the rotary tube contains a substance that increases the viscosity of quartz glass.

11. The method according to claim 10, wherein the substance has an alkali content of less than 0.5%.

12. The method according to claim 10, wherein the inner wall of the rotary tube consists of synthetically produced Al₂O₃.

13. The method according to claim 10, wherein the rotary tube contains Al₂O₃, and Al₂O₃ doping of the quartz glass granules in the range of 1-20 wt. ppm is thereby effected by using said Al₂O₃-containing rotary tube.

14. The method according to claim 1, wherein prior to vitrifying the SiO₂ granulate is subjected to cleaning by heating in a halogen-containing atmosphere, and that wherein the cleaning of the SiO₂ granulate is carried out in a second rotary kiln.

15. The method according to claim 14, wherein the second rotary kiln is used for drying and the cleaning the SiO₂ granulate and is subdivided into zones, including a drying zone and a cleaning zone, wherein adjacent zones are subdivided by separating screens with openings or by labyrinth traps.

16. The method according to claim 14, wherein the cleaning in the rotary tube is carried out in a chlorine-containing atmosphere at a temperature in the range between 900° C. and 1250° C.

17. The method according to claim 1, wherein the helium entrapped in the granular particles occupies a volume of at least 10 cm³/kg.

18. The method according to claim 1, wherein the treatment gas during vitrifying contains at least 95% helium.

19. The method according to claim 1, wherein the granulate particles have a mean grain size between 100 μm and 400 μm (D₅₀ value each time).

20. The method according to claim 1, wherein the rotary tube contains Al₂O₃. ZrO₂ or Si₃N₄.
